(19) United States
(12) Patent Application Publication
(10) Pub. No.: US 2026/0065840 A1
(43) Pub. Date: Mar. 5, 2026

(54) ELECTRONIC DEVICE

(71) Applicant: Samsung Display Co., LTD., Yongin-si (KR)

(72) Inventors: Chae Hee PARK, Yongin-si (KR); Woo Chul KIM, Yongin-si (KR)

(21) Appl. No.: 19/218,997

(22) Filed: May 27, 2025

(30) Foreign Application Priority Data
Sep. 2, 2024 (KR) 10-2024-0118810

(51) Int. Cl. G09G 3/20; G09G 3/3233

(52) U.S. Cl. CPC G09G 3/2096; G09G 3/3233; G09G 2300/0842; G09G 2340/0414

(57) ABSTRACT

An electronic device includes a display device including a data driver integrated circuit converting interfacing data into second data and a display panel displaying an image based on the second data; and a processor processing raw image data to provide the interfacing data to the display device. The processor further maintains a resolution of the interfacing data at a first resolution, which is a resolution of the raw image data, in a first mode, changes the resolution of the interfacing data to a second resolution different from the first resolution in a second mode different from the first mode, and maintains a frequency of the interfacing data constant.

The application claims priority to Korean Patent Application No. 10-2024-0118810, filed on Sep. 2, 2024, and all the benefits accruing therefrom under 35 U.S.C. § 119, the content of which in its entirety is herein incorporated by reference.

### BACKGROUND

### 1. Field

The disclosure relates to an electronic device.

### 2. Discussion of the Related Art

An electronic device may include a processor and a display device. The display device may include a data driver integrated circuit (“IC”) including a timing controller and a data driver. The processor and the display device or the timing controller and the data driver may transmit and receive signals desired to drive the electronic device (or the display device) through an interface.

### SUMMARY

In the case of driving the electronic device (or the display device) through an interface, when the display device displays a high-resolution image, unintended power consumption may occur depending on the frequency of a data signal exchanged between components. Accordingly, it is desired to control the resolution and frequency of the data signal depending on a driving mode.

A feature of the disclosure is to provide an electronic device in which the driving power consumption of the electronic device may be relatively reduced by controlling the resolution of a data signal exchanged between a processor and a display device according to a driving mode.

An electronic device in an embodiment of the disclosure includes a display device including a data driver integrated circuit (“IC”) converting interfacing data into second data and a display panel displaying an image based on the second data; and a processor processing raw image data to provide the interfacing data to the display device. The processor further maintains a resolution of the interfacing data at a first resolution, which is a resolution of the raw image data, in a first mode, changes the resolution of the interfacing data to a second resolution different from the first resolution in a second mode different from the first mode, and maintains a frequency of the interfacing data constant.

In an embodiment, the raw image data may include first line data corresponding to pixel rows arranged in one direction on the display panel, the second data may include second line data corresponding to the pixel rows, and in the first mode, each of the first line data may have a same data value as a data value of corresponding second line data.

In an embodiment, in the second mode, values of the first line data and values of the second line data in odd-numbered rows may be the same, and values of the first line data and values of the second line data in even-numbered rows may be different from each other.

In an embodiment, in the second mode, the second line data may include (2_1)th line data and (2_2)th line data corresponding to a row next (adjacent) to a row of the (2_1)th line data, and a value of the (2_1)th line data and a value of the (2_2)th line data may be the same.

In an embodiment, the processor may include a graphics processing unit converting the raw image data into rendering data; a first memory generating first data based on the rendering data; and an interfacing unit converting the first data into the interfacing data and outputting the interfacing data to the data driver IC.

In an embodiment, the graphics processing unit may convert a resolution of the rendering data to the second resolution in the second mode.

In an embodiment, the second resolution may have a lower vertical resolution than the first resolution.

In an embodiment, in the first mode, the first memory may read each of the first line data from the rendering data to generate the first data.

In an embodiment, in the second mode, the first memory may read the first line data corresponding to odd-numbered rows among the first line data from the rendering data to generate the first data.

In an embodiment, the processor may supply mode data regarding a driving mode to the display device.

An electronic device in an embodiment of the disclosure includes a display device including a data driver IC converting interfacing data into second data and a display panel displaying an image based on the second data; and a processor processing raw image data to provide the interfacing data to the display device. The data driver IC further maintains a resolution of the second data at a first resolution, which is a resolution of the raw image data, in a first mode, and changes the resolution of the second data to a second resolution different from the first resolution in a second mode different from the first mode.

In an embodiment, the processor may supply mode data regarding a driving mode to the data driver IC.

In an embodiment, the data driver IC may include a second memory generating padding data based on the interfacing data; and a scaler generating the second data based on the padding data and the mode data.

In an embodiment, in the second mode, the scaler may scale the padding data to change a resolution of the padding data to the second resolution, and generate the second data based on the padding data.

In an embodiment, the first resolution may have a resolution of 1080 by 2160.

In an embodiment, the second resolution may have a resolution of 1440 by 1440.

### BRIEF DESCRIPTION OF THE DRAWINGS

The accompanying drawings, which are included to provide a further understanding of the inventive concepts, and are incorporated in and constitute a part of this specification, illustrate embodiments of the inventive concepts, and, together with the description, serve to explain principles of the inventive concepts.

FIG. 1 is a block diagram illustrating an embodiment of a display system.

FIG. 2 is a block diagram illustrating an embodiment of a display device according to the disclosure.

FIG. 3 is a circuit diagram illustrating an embodiment of a pixel included in the display device of FIG. 2.

FIG. 4 is a diagram for explaining an embodiment of a data clock signal line and a common signal line connecting a timing controller and a data driver included in the display device of FIG. 2.

FIG. 5 is a diagram illustrating an embodiment of a signal supplied from the timing controller to the data driver in FIG. 4.

FIG. 6 is a block diagram illustrating components of a processor and a data driver integrated circuit (“IC”) in FIG. 1.

FIG. 7 is a diagram illustrating a data signal exchanged between the processor and the data driver IC in a first mode.

FIG. 8 is a diagram illustrating raw image data and a line data value of second data according to the first mode.

FIG. 9 is a diagram illustrating a data signal exchanged between the processor and the data driver IC in a second mode.

FIG. 10 is a diagram illustrating raw image data and a line data value of second data according to the second mode.

FIG. 11 is a diagram illustrating an embodiment of a data signal exchanged between a processor and a data driver IC in a second mode according to the disclosure.

FIG. 12 is a diagram illustrating an embodiment of a processor and components of a display device, and a data signal exchanged between them in a first mode.

FIG. 13 is a diagram illustrating an embodiment of the processor and the components of the display device, and a data signal exchanged between them in a second mode.

FIG. 14 is a perspective view illustrating an embodiment in which an electronic device of FIG. 1 is implemented as a smartphone.

FIG. 15 is a perspective view illustrating an embodiment in which the electronic device of FIG. 1 is implemented as a tablet personal computer (“PC”).

### DETAILED DESCRIPTION

Hereinafter, preferred embodiments according to the disclosure will be described in detail with reference to the accompanying drawings. It should be noted that in the following description, only parts desired for understanding the operation according to the disclosure are described, and descriptions of other parts will be omitted in order not to obscure the subject matter of the disclosure. In addition, the disclosure is not limited to the embodiments described herein and may be embodied in other forms. However, the embodiments described herein are provided to explain in detail so that those skilled in the art may easily practice the technical spirit of the disclosure.

Throughout the specification, when a first part is said to be connected or coupled to a second part, this includes not only a case where the first part and the second part are directly connected or coupled, but also a case where they are indirectly connected or coupled by another element interposed between them. Terms used herein are for describing illustrative embodiments and are not intended to limit the disclosure. Throughout the specification, when a part includes a certain component, unless the context clearly indicates otherwise, this means that it may further include other components rather than excluding other components. At least one of X, Y, and Z, and at least one selected from the group consisting of X, Y, and Z may be construed as one X, one Y, one Z, or any combination of two or more of X, Y, and Z (for example, XYZ, XYY, YZ, and ZZ). As used herein, the term “and/or” may include any combination of one or more of the corresponding elements.

Although the terms “first”, “second”, etc. may be used herein to describe various elements, these elements should not be limited by these terms. These terms are only used to distinguish one element from another element. Thus, a first element discussed below could be termed a second element without departing from the scope of the disclosure.

Spatially relative terms such as “beneath”, “below”, “under”, “lower”, “above”, “upper”, “over”, and the like may be used herein for descriptive purposes. By doing so, the relationship between one element or feature and another element(s) or feature(s) is explained, as shown in the drawings. Spatially relative terms are intended to include other directions in use, operation, and/or manufacture, in addition to the directions depicted in the drawings. For example, when the device shown in the drawings is turned upside down, elements depicted as being “below” or “beneath” other elements or features are positioned “above” the other elements or features. Thus, in an embodiment, the term “below” may include both directions “above” and “below”. In addition, the device may be oriented in other directions (for example, rotated 90 degrees or in other directions). Accordingly, the spatially relative terms used herein may be interpreted accordingly.

The terms such as “unit”, “processor” and “scaler” as used herein are intended to mean a hardware component such as a circuitry that performs a predetermined function. The hardware component may include a field-programmable gate array (“FPGA”) or an application-specific integrated circuit (“ASIC”), for example.

Various embodiments are described with reference to the drawings that ideal embodiments are schematically illustrated. Accordingly, it will be expected that their shapes may vary depending on tolerances and/or manufacturing techniques, for example. Accordingly, the embodiments disclosed herein should not be construed as being limited to the predetermined shapes shown in the drawings. In an embodiment, it should be interpreted to include changes in shape that occur as a result of manufacturing. As such, the shapes shown in the drawings may not illustrate the actual shapes of areas of the device, and the illustrated embodiments may not be limited thereto.

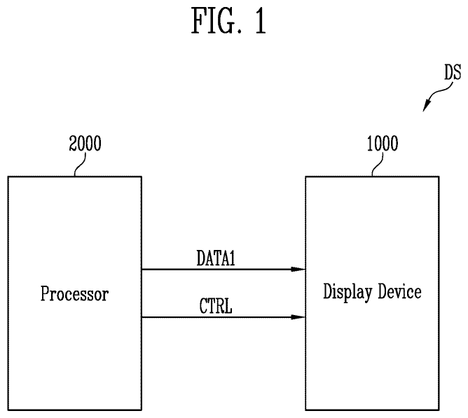

FIG. 1 is a block diagram illustrating an embodiment of a display system.

Referring to FIG. 1, a display system DS may include a display device 1000 and a processor 2000.

The processor 2000 may perform various tasks and calculations. In some embodiments, the processor 2000 may include an application processor, a graphics processor, a microprocessor, a central processing unit (“CPU”), or the like. The processor 2000 may be connected to other components of the display system DS through a bus system to control them.

The processor 2000 may transmit first data DATA1 and a control signal CTRL to the display device 1000. The display device 1000 may display an image based on the first data DATA1 and the control signal CTRL. The processor 2000 may be disposed (e.g., mounted) inside the display device 1000.

The first data DATA1 and the control signal CTRL may be transmitted and received between the processor 2000 and the display device 1000 through an interface (e.g., a serial programming interface (“SPI”), an inter integrated circuit (“I2C”), a mobile industry processor interface (“MIPI”), or the like).

The display system DS may include a computing system providing an image display function, such as an electronic device such as a smart watch, a mobile phone, a smart phone, a portable computer, a tablet personal computer, a watch phone, an automotive display, smart glasses, a portable multimedia player (“PMP”), a navigation system, or an ultra-mobile personal computer (“UMPC”). In addition, the display system DS may include at least one of a head-mounted display (“HMD”) device, a virtual reality (“VR”) device, a mixed reality (“MR”) device, and an augmented reality (“AR”) device.

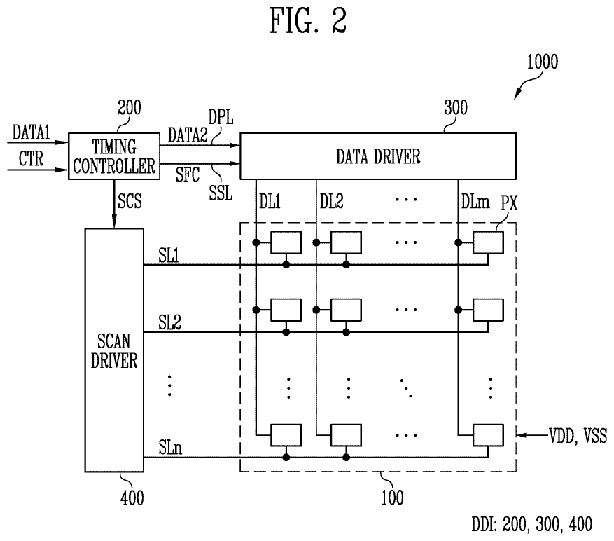

FIG. 2 is a block diagram illustrating an embodiment of a display device according to the disclosure.

Referring to FIG. 2, the display device 1000 in embodiments of the disclosure may include a pixel unit 100 (or a display panel), a timing controller 200, a data driver 300, and a scan driver 400.

The pixel unit 100 may include a plurality of scan lines SL1 to SLn, a plurality of data lines DL1 to DLm, and a plurality of pixels PX, where n and m may be integers greater than 0.

The pixels PX may be connected to at least one of the scan lines SL1 to SLn and at least one of the data lines DL1 to DLm. Each of the pixels PX may emit light with a luminance corresponding to a data signal provided through a corresponding data line in response to a scan signal provided through a corresponding scan line. The pixels PX may be supplied with voltages of a first power source VDD and a second power source VSS from outside. Here, the first power source VDD and the second power source VSS may be voltages desired to drive the pixels PX. In an embodiment, the first power source VDD may have a voltage level higher than a voltage level of the second power source VSS, for example.

The timing controller 200 may receive the control signal CTRL and the first data DATA1 from the outside (e.g., the processor 2000 shown in FIG. 1). Here, the control signal CTRL may include a clock signal, a vertical synchronization signal, a horizontal synchronization signal, or the like.

The timing controller 200 may generate a scan control signal SCS based on the control signal CTRL and supply the scan control signal SCS to the scan driver 400.

In addition, the timing controller 200 may generate second data DATA2 based on the control signal CTRL and the first data DATA1, and supply the second data DATA2 to the data driver 300 through a data clock signal line DPL. In some embodiments, the timing controller 200 may generate a data control signal based on the control signal CTRL, generate frame data based on the control signal CTRL and the first data DATA1, configure the data control signal and the frame data into the second data DATA2 which is one packet data, and supply the second data DATA2 to the data driver 300 through the data clock signal line DPL.

The data control signal may include a signal desired for the initialization operation of the data driver 300, e.g., a clock training signal or the like. The clock training signal may include a clock training pattern. In addition, the frame data may include pixel data or the like.

The timing controller 200 may supply a training notification signal SFC to the data driver 300 through a common signal line SSL to notify of a section (or clock training section) in which the clock training pattern of the clock training signal is supplied. In an embodiment, the timing controller 200 may supply the training notification signal SFC of a first level (or a logic low level) to the data driver 300 in response to the clock training section, and may supply the training notification signal SFC of a second level (or a logic high level) higher than the first level to the data driver 300 in response to other sections, for example.

The data driver 300 may determine the clock training section during a vertical blank period of one frame based on the training notification signal SFC of the first level (or logic low level) provided from the timing controller 200 through the common signal line SSL. The data driver 300 may generate (or restore) a clock signal based on the second data DATA2 in the clock training section. In an embodiment, the data driver 300 may include a clock data recovery (“CDR”) circuit, for example. The clock data recovery circuit may generate the clock signal based on a clock training signal of the second data DATA2 in the clock training section.

The data driver 300 may generate data signals based on the second data DATA2 in an active data period of one frame. In an embodiment, the data driver 300 may generate the data signals based on the frame data included in the second data DATA2 and the clock signal generated (or restored) in the clock training section, for example.

The vertical blank period and the active data period in which the data driver 300 generates the clock signal and second data signals may correspond to a second period (or data period).

Accordingly, the data driver 300 may supply the data signals to the data lines DL1 to DLm.

The scan driver 400 may receive the scan control signal SCS from the timing controller 200 and supply scan signals to the scan lines SL1 to SLn based on the scan control signal SCS. In an embodiment, the scan signals may be supplied sequentially to the scan lines SL1 to SLn, for example.

A scan signal may be set to a gate-on voltage (e.g., a relatively low voltage or a relatively high voltage). A transistor receiving the scan signal may be set to a turned-on state when the scan signal is supplied.

In FIG. 2, the components 200, 300, and 400 that supply signals, voltages, or the like to the display panel 100 are merely classified according to their functions. In an embodiment, the timing controller 200, the data driver 300, and the scan driver 400 may be formed within a single integrated circuit, for example. In other words, the timing controller 200, the data driver 300, and the scan driver 400 may be implemented as a single data driver IC DDI.

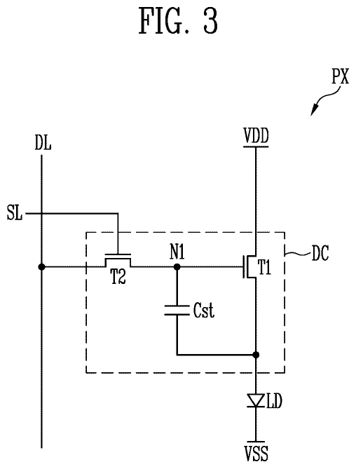

FIG. 3 is a circuit diagram illustrating an embodiment of a pixel included in the display device of FIG. 2.

Referring to FIG. 3, a pixel PX may include a light-emitting element LD and a driving circuit DC connected thereto to drive the light-emitting element LD.

A first electrode (e.g., an anode electrode) of the light-emitting element LD may be connected to the first power source VDD via the driving circuit DC, and a second electrode (e.g., a cathode electrode) of the light-emitting element LD may be connected to the second power source VSS. The light-emitting element LD may emit light with a luminance corresponding to the amount of driving current controlled by the driving circuit DC.

The light-emitting element LD may include an organic light-emitting diode (“OLED”) or an inorganic light-emitting diode such as a micro light-emitting diode (“LED”) or a quantum dot light-emitting diode (“QD”). In addition, the light-emitting element may be a light-emitting element composed of a composite of organic and inorganic materials. In FIG. 3, the pixel PX is shown as including a single light-emitting element LD, but in other embodiments, the pixel PX may include a plurality of light-emitting elements, and the plurality of light-emitting elements may be connected in series, in parallel, or in series and parallel.

The first power source VDD and the second power source VSS may have different potentials. In an embodiment, a voltage applied through the first power source VDD may be greater than a voltage applied through the second power source VSS, for example.

The driving circuit DC may include a first transistor T1, a second transistor T2, and a storage capacitor Cst.

A first electrode of the first transistor (also referred to as a driving transistor) T1 may be connected to the first power source VDD, and a second electrode of the first transistor T1 may be electrically connected to the first electrode (e.g., the anode electrode) of the light-emitting element LD. A gate electrode of the first transistor T1 may be connected to a first node N1. The first transistor T1 may control the amount of driving current supplied to the light-emitting element LD in response to a data signal supplied to the first node N1 through a data line DL.

A first electrode of the second transistor (also referred to as a switching transistor) T2 may be connected to the data line DL, and a second electrode of the second transistor T2 may be connected to the first node N1. A gate electrode of the second transistor T2 may be connected to a scan line SL.

The second transistor T2 may electrically connect the data line DL and the first node N1 by being turned on when a scan signal of a voltage (e.g., a gate-on voltage) that may be turned on is supplied from the scan line SL. In this case, the data signal of a corresponding frame may be supplied to the data line DL, and accordingly, the data signal may be transmitted to the first node N1. A voltage corresponding to the data signal transmitted to the first node N1 may be stored in the storage capacitor Cst.

One electrode of the storage capacitor Cst may be connected to the first node N1, and a remaining (the other) electrode of the storage capacitor Cst may be connected to the first electrode of the light-emitting element LD. The storage capacitor Cst may be charged with a voltage corresponding to the data signal supplied to the first node N1, and may maintain the charged voltage until the data signal of the next frame is supplied.

FIG. 3 shows the pixel PX having a relatively simple structure for convenience of description, but the structure of the driving circuit DC may be changed in various ways. In an embodiment, the driving circuit DC may further include other circuit elements, such as various transistors, such as a compensation transistor for compensating a threshold voltage of the first transistor T1, an initialization transistor for initializing the first node N1, and/or an emission control transistor for controlling the light-emitting time of the light-emitting element LD, and a boosting capacitor for boosting the voltage of the first node N1.

In addition, in FIG. 3, the transistors included in the driving circuit DC, e.g., the first and second transistors T1 and T2, are shown as N-type transistors, but the disclosure is not limited thereto. That is, at least one of the first and second transistors T1 and T2 included in the driving circuit DC may be changed to a P-type transistor.

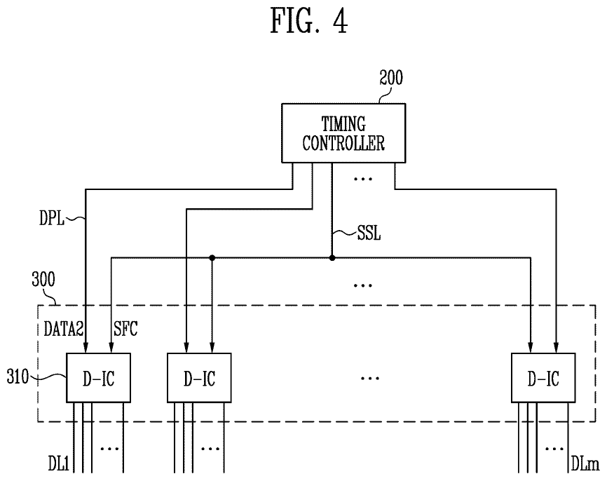

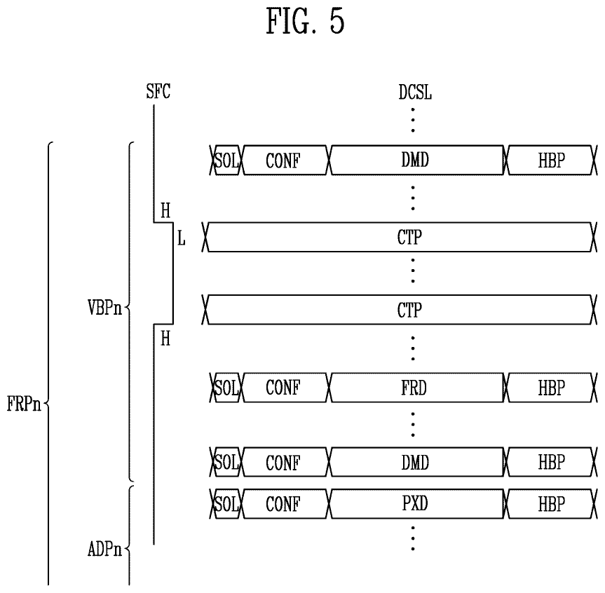

FIG. 4 is a diagram for explaining an embodiment of a data clock signal line and a common signal line connecting a timing controller and a data driver included in the display device of FIG. 2. FIG. 5 is a diagram illustrating an embodiment of a signal supplied from the timing controller to the data driver in FIG. 4.

Referring to FIG. 4, the data driver 300 may include data driving circuits 310. Here, the data driving circuits 310 may also be referred to as a driver IC (“D-IC”) or source IC.

The data driving circuits 310 may be connected to at least one of the data lines DL1 to DLm. In an embodiment, when the data driver 300 includes only one data driving circuit 310, the data driving circuit 310 and the data driver 300 may be the same, for example. In this case, all of the data lines DL1 to DLm may be connected to one data driving circuit 310. In another embodiment, when the data driver 300 includes a plurality of data driving circuits 310, the data lines DL1 to DLm may be grouped, and each of data line groups may be connected to a corresponding data driving circuit 310. In an embodiment, the data driver 300 may include m data driving circuits 310 which are the same as the number of data lines DL1 to DLm, for example. In this case, each of data line groups may include one data line, and the m data driving circuits 310 may be connected to the m data lines DL1 to DLm (or data line groups), respectively. In another embodiment, the data driving circuits 310 may include m divided by j (m/j) data driving circuits 310, where j may be an integer greater than or equal to 2 and less than m. In this case, each of data line groups may include j data lines, and the m/j data driving circuits 310 may be connected to j data lines (or data line groups) among the m data lines DL1 to DLm, respectively.

The timing controller 200 and the data driver 300 may be connected to each other through the data clock signal line DPL and the common signal line SSL.

In an embodiment, the timing controller 200 may be connected to each of the data driving circuits 310 included in the data driver 300 through the data clock signal line DPL. In an embodiment, a method by which the timing controller 200 is connected to the data driving circuits 310 included in the data driver 300 through the data clock signal line DPL may be a point-to-point method, for example. Here, the data clock signal line DPL may include the same number of sub data clock signal lines as the number of data driving circuits 310. In this case, the timing controller 200 may be connected to each of the data driving circuits 310 through the sub data clock signal lines.

The data clock signal line DPL may correspond to an interface for transmitting the second data DATA2 provided from the timing controller 200 to the data driver 300 (or the data driving circuits 310). In an embodiment, the data clock signal line DPL may be a high-speed serial interface, for example. In an embodiment, the data clock signal line DPL may be a universal serial interface (“USI”), a universal serial interface for television (“USI-T”), an ultra path interface (“UPI”), a universal description, discovery and integration (“UDDI”), or the like, for example.

The second data DATA may be data embedded with a clock. In an embodiment, as described with reference to FIG. 2, the second data DATA2 may include the data control signal (clock training signal) and the frame data, for example. In this case, since the timing controller 200 and each of the data driving circuits 310 included in the data driver 300 are connected through the data clock signal line DPL, the timing controller 200 may supply the second data DATA2 corresponding to each of the data driving circuits 310 through the data clock signal line DPL.

In addition, as described with reference to FIG. 2, the common signal line SSL may correspond to a signal transmission channel for transmitting the training notification signal SFC provided from the timing controller 200 to the data driver 300 (or the data driving circuits 310).

In an embodiment, the timing controller 200 may be commonly connected to the data driving circuits 310 included in the data driver 300 through the common signal line SSL. In an embodiment, a method by which the timing controller 200 is connected to the data driving circuits 310 through the common signal line SSL may be a multi-drop method, for example.

Since the timing controller 200 and the data driving circuits 310 are commonly connected through the common signal line SSL, in the clock training section, the timing controller 200 may simultaneously supply the training notification signal SFC of the first level (or logic low level) that notifies the supply of the clock training signal to all the data driving circuits 310 through one common signal line SSL.

Referring to FIG. 5, a frame period for each image frame may include a vertical blank period and an active data period. In an embodiment, an n-th frame period FRPn may include an n-th vertical blank period VBPn and an n-th active data period ADPn, for example.

The n-th active data period ADPn may be a period in which grayscale values constituting an image frame to be displayed on the display panel 100 are supplied. The grayscale values may be included in pixel data PXD (or image data).

The n-th vertical blank period VBPn may be disposed before the n-th active data period ADPn of the current frame. During the n-th vertical blank period VBPn, clock training, frame setup, and dummy data supply may be performed. The vertical blanking period VBPn may include (e.g., sequentially include) a period in which dummy data DMD is supplied, a period in which a clock training pattern CTP is supplied, a period in which frame data FRD is supplied, and a period in which dummy data DMD is supplied.

The timing controller 410 may notify the data driver 300 that the clock training pattern CTP is being supplied to the data clock signal line DCSL by applying the clock training signal of a low logic level (L) to a shared signal line SFC during the n-th vertical blank period VBPn. The timing controller 410 may apply the clock training signal of a high logic level (H) to the shared signal line SFC when the clock training pattern CTP is not supplied.

During the active data period ADPn, a start-of-line packet SOL, a line setup packet CONF, an image data packet (e.g., the pixel data PXD, the frame data FRD, or the dummy data DMD), and a horizontal blank period packet HBP may be sequentially supplied in units of pixel rows.

The start-of-line packet SOL may have the function of notifying the data driving circuit 310 that the supply of signals for a changed pixel row has begun.

The frame data FRD may be data after synchronization is completed. In other words, the frame data FRD may be synchronized by the clock training signal.

The horizontal blank period packet HBP may have the function of notifying the data driving circuit 310 that a pixel row (e.g., pixels connected to the same scan line) corresponding to the image data packet such as the pixel data PXD has changed.

The line setup packet CONF may include the operation option of the data driving circuit 310. In an embodiment, the line setup packet CONF may indicate that the subsequent data is the pixel data PXD or the dummy data DMD, for example.

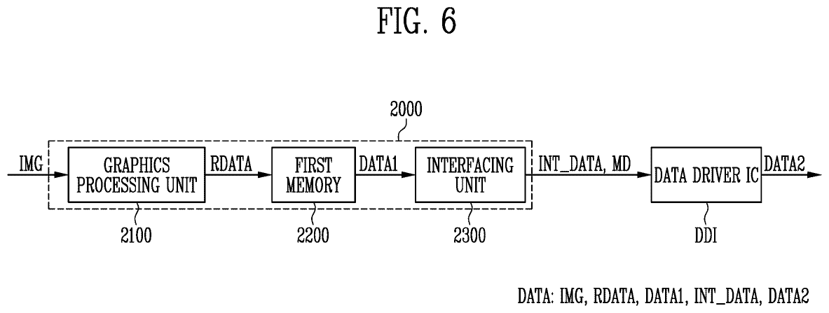

FIG. 6 is a block diagram illustrating components of a processor and a data driver IC in FIG. 1.

Referring to FIG. 6, the processor 2000 may include a graphics processing unit 2100, a first memory 2200, and an interfacing unit 2300.

The graphics processing unit 2100 may be supplied with raw image data IMG. The graphics processing unit 2100 may render the supplied raw image data IMG. In other words, the graphics processing unit 2100 may generate rendering data RDATA in which the raw image data IMG is rendered.

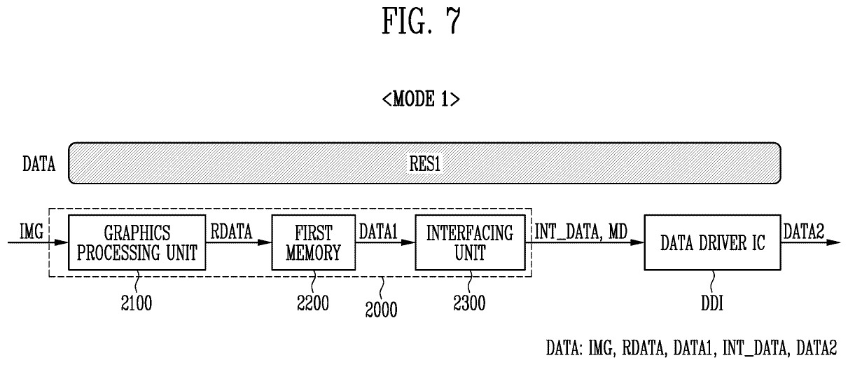

The first memory 2200 may generate the first data DATA1 based on the rendering data RDATA. In an embodiment, the first memory 2200 may generate different first data DATA1 according to the driving mode based on the rendering data RDATA, for example. This will be described in detail later with reference to FIGS. 7 to 11.

The interfacing unit 2300 may convert the first data DATA1 received from the first memory 2200 into interfacing data INT_DATA and output the interfacing data INT_DATA to the outside. In an embodiment, the interfacing unit 2300 may output the interfacing data INT_DATA to the data driver IC DDI, for example. In this case, the interfacing unit 2300 may form one interface system between the processor 2000 and the data driver IC DDI. That is, the interfacing unit 2300 may interface signals exchanged between the processor 2000 and the data driver IC DDI. In this case, when the frequency of a signal provided from the processor 2000 to the data driver IC DDI changes, unintended power consumption may occur when the display device 1000 (refer to FIG. 1) is driven. Accordingly, it may be desired to maintain the frequency of the interfacing data INT_DATA exchanged between the processor 2000 and the data driver IC DDI constant.

The interfacing unit 2300 may provide mode data MD to the data driver IC DDI. The mode data MD may include information about the driving mode of the display device 1000 (refer to FIG. 1). In an embodiment, the display device 1000 may be driven in a first mode that displays an image at a normal resolution, for example. The display device 1000 may be driven in a second mode that displays an image with a relatively higher resolution than the first mode. In this case, a driving logic of the display device 1000 may be different depending on the driving mode, and the display device 1000 may be driven according to different driving logic depending on the input mode data MD.

The data driver IC DDI may be provided with the mode data MD and the interfacing data INT_DATA. Accordingly, the data driver IC DDI may generate the second data DATA2 based on the mode data MD and the interfacing data INT_DATA. In an embodiment, the data driver IC DDI may process the second data DATA2 according to the driving mode and supply it to the display panel 100 (refer to FIG. 1), for example. In this case, the second data DATA2 may correspond to the second data DATA2 described with reference to FIGS. 4 and 5.

In FIGS. 6, 7, 9 and 10, an embodiment in which the interfacing unit 2300 transmits the mode data MD to the data driver IC DDI is shown, but the disclosure is not limited thereto. In an embodiment, another component of the processor 2000 may transmit the mode data MD to the data driver IC DDI, for example.

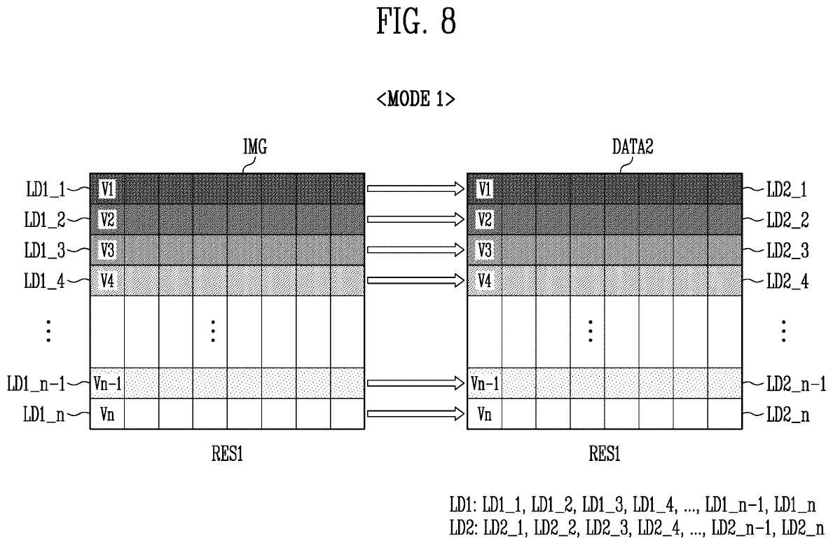

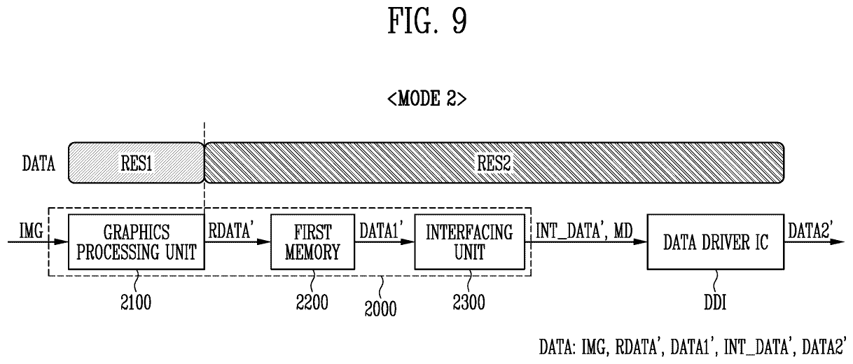

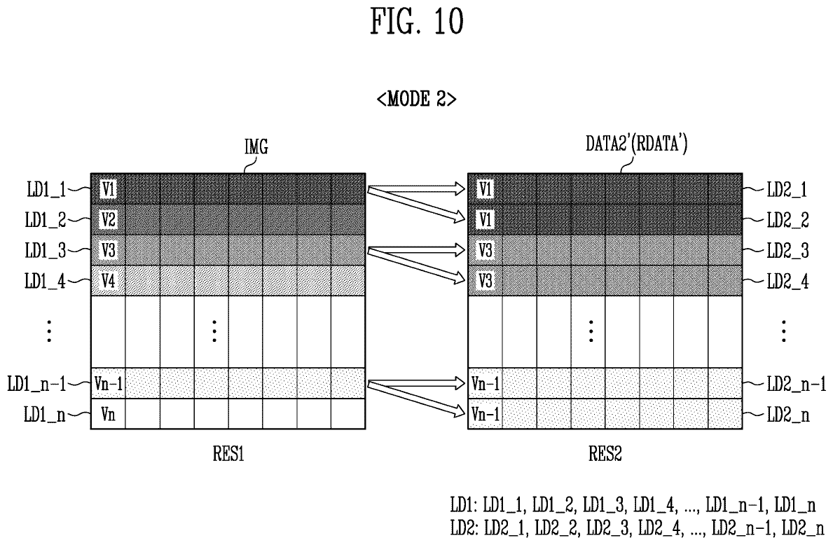

FIG. 7 is a diagram illustrating a data signal exchanged between the processor and the data driver IC in a first mode. FIG. 8 is a diagram illustrating raw image data and a line data value of second data according to the first mode. FIG. 9 is a diagram illustrating a data signal exchanged between the processor and the data driver IC in a second mode. FIG. 10 is a diagram illustrating raw image data and a line data value of second data according to the second mode.

FIGS. 7 and 9 focus on the resolution of data signals DATA exchanged between the processor 2000 and the data driver IC DDI in the first mode and the second mode. In addition, the graphics processing unit 2100, the first memory 2200, the interfacing unit 2300, and the data driver IC DDI of FIGS. 7 and 9 may be described similarly to the graphics processing unit 2100, the first memory 2200, the interfacing unit 2300, and the data driver IC DDI of FIG. 6.

First, referring to FIG. 7, in the first mode, a value of the resolution corresponding to a data signal DATA may be constant. In an embodiment, in the first mode, values of the resolution corresponding to the raw image data IMG, the rendering data RDATA, the first data DATA1, the interfacing data INT_DATA, and the second data DATA2 may have a first resolution RES1, for example.

Referring to FIGS. 2 and 8, the raw image data IMG may include first line data LD1 corresponding to pixel rows of the pixels PX (refer to FIG. 2) of the display panel 100 (refer to FIG. 2). In an embodiment, the pixel rows of the pixels PX of the display panel 100 may have n rows, for example. In this case, each pixel row of the pixels PX may be driven based on (1_1)th line data LD1_1 to (1_n)th line data LD1_n.

In addition, the second data DATA2 may include second line data LD2 corresponding to the pixel PX rows of the display panel 100. In an embodiment, the pixel rows of the pixels PX of the display panel 100 may have n rows, for example. In this case, each pixel row of the pixels PX may be driven based on (2_1)th line data LD2_1 to (2_n)th line data LD2_n.

The first line data LD1 and the second line data LD2 may include any one of first to n-th data values V1 to Vn. In this case, it may be assumed that each of the first to n-th data values V1 to Vn corresponds to a data value of a predetermined color of a pixel (e.g., a red data value corresponding to a red sub-pixel, a blue data value corresponding to a blue sub-pixel, or a green data value corresponding to a green sub-pixel).

In the first mode, line data values of the raw image data IMG and the second data DATA2 may be the same. In an embodiment, in the first mode, the first line data LD1 and the second line data LD2 may be the same, for example. In other words, the (1_1)th line data LD1_1 to the (1_n)th line data LD1_n may have the same data values as data values of the (2_1)th line data LD2_1 to the (2_n)th line data LD2_n, respectively. Accordingly, in the first mode, the resolution corresponding to the raw image data IMG and the resolution corresponding to the second data DATA2 may be the same as the first resolution RES1.

Referring to FIG. 9, in the second mode, the graphics processing unit 2100 may convert the raw image data IMG into rendering data RDATA′. Accordingly, the first memory 2200 may generate first data DATA1′ based on the rendering data RDATA′. Thereafter, the interfacing unit 2300 may convert the first data DATA1′ into interfacing data INT_DATA′ and supply the interfacing data INT_DATA′ to the data driver IC DDI. The data driver IC DDI may generate second data DATA2′ based on the interfacing data INT_DATA′ and the mode data MD. Accordingly, the display panel 100 (refer to FIG. 2) may display an image corresponding to the second data DATA2′.

In the second mode, the resolution of the data signal DATA may be converted from the first resolution RES1 to a second resolution RES2. In an embodiment, a value of the resolution corresponding to the raw image data IMG may have the first resolution RES1, for example. Values of the resolution corresponding to the rendering data RDATA′, the first data DATA1′, the interfacing data INT_DATA′, and the second data DATA2′ may have a value of the second resolution RES2. In other words, the graphics processing unit 2100 may convert the resolution of the rendering data RDATA′ to the second resolution RES2 and render the raw image data IMG. Accordingly, a value of the resolution corresponding to the data signal DATA generated thereafter may be the second resolution RES2.

Referring to FIGS. 9 and 10 together, in the second mode, values of the second line data LD2 of odd-numbered rows may be the same as values of the first line data LD1 of the odd-numbered rows. In an embodiment, the (2_1)th line data LD2_1 may have a first data value V1, and the (1_1)th line data LD1_1 may also have the first data value V1, for example. In addition, (2_3)th line data LD2_3 may have a third data value V3, and (1_3)th line data LD1_3 may also have the third data value V3. In addition, (2_n−1)th line data LD2_n−1 may have an (n−1)th data value Vn−1, and (1_n−1)th line data LD1_n−1 may also have the (n−1)th data value Vn−1.

In the second mode, values of the second line data LD2 of even-numbered rows may be different from values of the first line data LD1 of the even-numbered rows. In an embodiment, (2_2)th line data LD2_2 may have the first data value V1, and (1_2)th line data LD1_2 may have a second data value V2. In addition, (2_4)th line data LD2_4 may have the third data value V3, and (1_4)th line data LD1_4 may have a fourth data value V4. In addition, the (2_n)th line data LD2_n may have the (n−1)th data value Vn−1. The (1_n)th line data LD1_n may have an n-th data value Vn.

In the second mode, the graphics processing unit 2100 may generate the rendering data RDATA′ so that values of the first line data LD1 and the second line data LD2 are different from each other. In an embodiment, that is, the graphics processing unit 2100 may generate the rendering data RDATA′ so that the vertical resolution of the rendering data RDATA′ (or the second data DATA2′) is relatively lower than that of the raw image data IMG, for example. In an embodiment, when processing the second line data LD2 of the odd-numbered rows, the graphics processing unit 2100 may generate the rendering data RDATA′ to have the same data value as the first line data LD1, for example. When processing the second line data LD2 of the even-numbered rows, the graphics processing unit 2100 may generate the rendering data RDATA′ to have the same data value as the first line data LD1 of a previous row of a corresponding row. Accordingly, the raw image data IMG may have the first resolution RES1, and the rendering data RDATA′ (or the second data DATA2′) may have the second resolution RES2. FIG. 10 shows the second data DATA2′ (or the rendering data RDATA′) for convenience of description, but any one of the data signals DATA may also be described similarly. In an embodiment, the first data DATA1′ and the interfacing data INT_DATA′ may also be described similarly, for example.

In embodiments of the disclosure, power consumption that is unintentionally consumed when the display device 1000 is driven may be reduced. In an embodiment, when the display device 1000 displays a high-resolution image, power consumption may increase to drive the display device 1000, for example. In an embodiment, when the frequency of the data signal DATA (e.g., the interfacing data INT_DATA′) generated between the processor 2000 and the display device 1000 changes, power consumption may relatively increase to drive the display device 1000, for example. In this case, the frequency of the interfacing data INT_DATA′ may be maintained constant by changing the resolution of the rendering data RDATA′ by the graphics processing unit 2100. Accordingly, the driving power consumption of the display device 1000 may be relatively reduced.

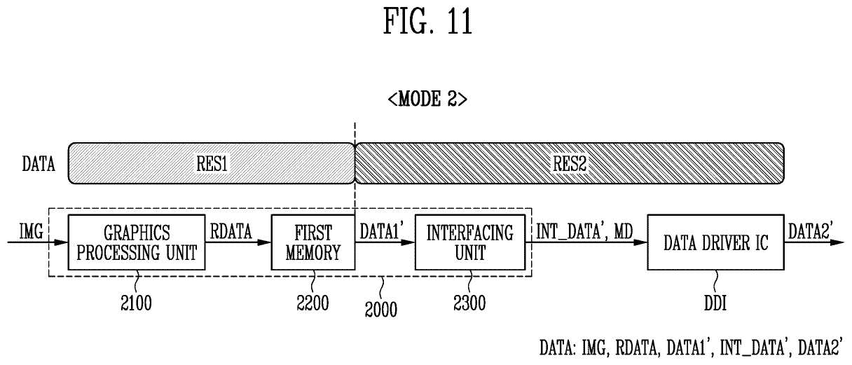

FIG. 11 is a diagram illustrating an embodiment of a data signal exchanged between a processor and a data driver IC in a second mode according to the disclosure.

The graphics processing unit 2100, the first memory 2200, the interfacing unit 2300, and the data driver IC DDI of FIG. 11 may be described similarly to the graphics processing unit 2100, the first memory 2200, the interfacing unit 2300, and the data driver IC DDI of FIG. 6.

Referring to FIG. 11, in the second mode, the graphics processing unit 2100 may convert the raw image data IMG into the rendering data RDATA. Accordingly, the first memory 2200 may generate the first data DATA1′ based on the rendering data RDATA. In this case, the first memory 2200 may read line data of odd-numbered rows among the second line data LD2 of the rendering data RDATA to generate the first data DATA1′. Accordingly, the first data DATA1′ may include line data substantially the same as the second data DATA2′ shown in FIG. 10.

Thereafter, the interfacing unit 2300 may convert the first data DATA1′ into the interfacing data INT_DATA′ and supply the interfacing data INT_DATA′ to the data driver IC DDI. The data driver IC DDI may generate the second data DATA2′ based on the interfacing data INT_DATA′ and the mode data MD. Accordingly, the display panel 100 (refer to FIG. 2) may display an image corresponding to the second data DATA2′.

In the second mode, the resolution of the data signal DATA may be converted from the first resolution RES1 to the second resolution RES2. In an embodiment, a value of the resolution corresponding to the raw image data IMG may have the first resolution RES1. Values of the resolution corresponding to the first data DATA1′, the interfacing data INT_DATA′, and the second data DATA2′ may have the value of the second resolution RES2.

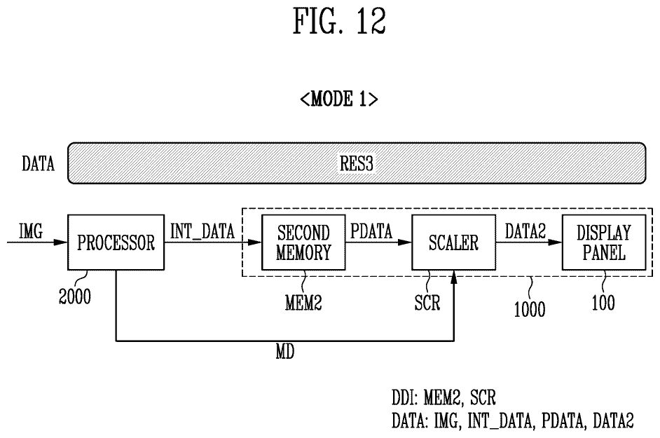

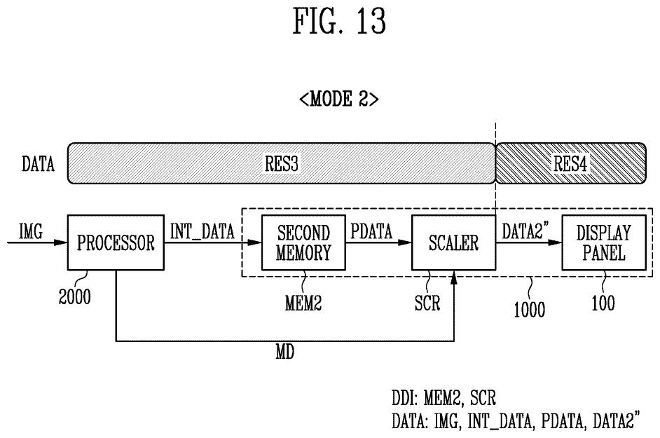

FIG. 12 is a diagram illustrating an embodiment of a processor and components of a display device, and a data signal exchanged between them in a first mode. FIG. 13 is a diagram illustrating an embodiment of the processor and the components of the display device, and a data signal exchanged between them in a second mode.

Referring to FIG. 12, the processor 2000 may generate the interfacing data INT_DATA based on the raw image data IMG and supply the interfacing data INT_DATA to the display device 1000.

The display device 1000 may include a second memory MEM2, a scaler SCR, and a display panel 100. In this case, the display panel 100 of FIGS. 12 and 13 may be described similarly to the display panel 100 of FIG. 2.

The second memory MEM2 may generate padding data PDATA based on the interfacing data INT_DATA. In an embodiment, the second memory MEM2 may be a padding circuit implemented in hardware, including a logic circuit, a memory element, or the like. In an embodiment, a padding value may be determined based on an offset value stored based on the interfacing data INT_DATA, for example. The offset value may be preset during a manufacturing process of the display device 100 or provided from an external device (e.g., a separate input terminal for setting). The determined padding value may be added to the first line data LD1 (refer to FIG. 8) to generate the padding data PDATA. The second memory MEM2 may provide the padding data PDATA to the scaler SCR.

The scaler SCR may generate the second data DATA2 based on the padding data PDATA. In an embodiment, the scaler SCR, in an embodiment, may convert the resolution of the data signal DATA through scaling to generate the second data DATA2. In an embodiment, in the first mode, the scaler SCR may generate the second data DATA2 without converting the resolution of the data signal DATA. In an embodiment, the second data DATA2 may be generated so that the resolution of the data signal DATA maintains the third resolution RES3, for example. The scaler SCR may provide the second data DATA2 to the display panel 100, and the display panel 100 may display an image based on the second data DATA2.

The processor 2000 may provide the mode data MD to the scaler SCR. The mode data MD of FIG. 12 may be described similarly to the mode data MD of FIG. 6.

Referring to FIG. 13, in the second mode, the scaler SCR may generate second data DATA2″. In this case, the scaler SCR may receive the mode data MD and scale the padding data PDATA to generate the second data DATA2″. In an embodiment, the scaler SCR may receive the mode data MD and scale the padding data PDATA to a size corresponding to a fourth resolution RES4 to generate the second data DATA2″, for example.

In an embodiment, the third resolution RES3 may have a resolution of 1080 by 2160 (1080×2160). The fourth resolution RES4 may have a resolution of 1440 by 1440 (1440×1440). However, this is only an illustrative embodiment, and the disclosure is not limited thereto.

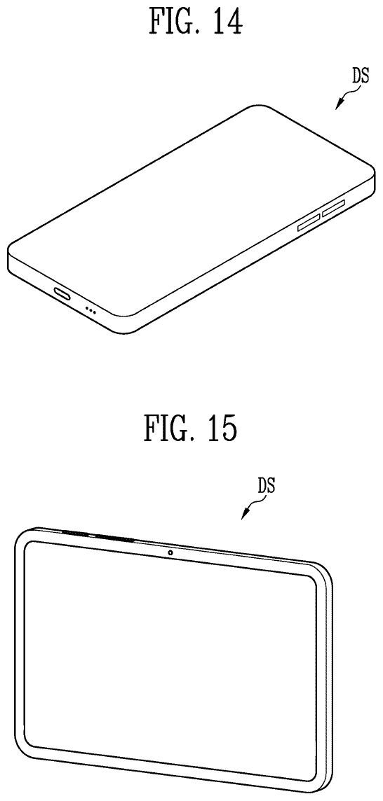

FIG. 14 is a perspective view illustrating an embodiment in which an electronic device of FIG. 1 is implemented as a smartphone. FIG. 15 is a perspective view illustrating an embodiment in which the electronic device of FIG. 1 is implemented as a tablet personal computer (“PC”).

Referring to FIG. 14, a smartphone DS including the display device 1000 (refer to FIG. 1) in embodiments of the disclosure may relatively reduce the driving power consumption.

Referring to FIG. 15, a tablet PC including the display device 1000 in embodiments of the disclosure may relatively reduce the driving power consumption.

In the embodiments of the disclosure, the driving power consumption of an electronic device may be relatively reduced by controlling the resolution of a data signal exchanged between a processor and a display device according to a driving mode.

Effects in the embodiments of the disclosure are not limited to those described above, and various other effects are included in the specification.

Although illustrative embodiments and applications have been described herein, other embodiments and variations may be derived from the above description. Accordingly, the spirit of the disclosure is not limited to these embodiments, but extends to the scope of the claims set forth below, various obvious modifications, and equivalents.

What is claimed is:

1. An electronic device comprising:
a display device including:
a data driver integrated circuit which converts interfacing data into second data; and
a display panel which displays an image based on the second data; and
a processor which:
processes raw image data and provides the interfacing data to the display device,
maintains a resolution of the interfacing data at a first resolution, which is a resolution of the raw image data, in a first mode,
changes the resolution of the interfacing data to a second resolution different from the first resolution in a second mode different from the first mode, and
maintains a frequency of the interfacing data constant.

2. The electronic device of claim 1, wherein the raw image data includes first line data corresponding to pixel rows arranged in one direction on the display panel,
wherein the second data includes second line data corresponding to the pixel rows, and
wherein in the first mode, each of the first line data has a same data value as a data value of corresponding second line data.

3. The electronic device of claim 2, wherein in the second mode, values of the first line data and values of the second line data in odd-numbered rows are identical to each other, and values of the first line data and values of the second line data in even-numbered rows are different from each other.

4. The electronic device of claim 3, wherein in the second mode, the second line data includes (2_1)th line data and (2_2)th line data corresponding to a row next to a row of the (2_1)th line data, and
wherein a value of the (2_1)th line data and a value of the (2_2)th line data are identical to each other.

5. The electronic device of claim 2, wherein the processor includes:
a graphics processing unit which converts the raw image data into rendering data;
a first memory which generates first data based on the rendering data; and
an interfacing unit which converts the first data into the interfacing data and outputs the interfacing data to the data driver integrated circuit.

6. The electronic device of claim 5, wherein the graphics processing unit converts a resolution of the rendering data to the second resolution in the second mode.

7. The electronic device of claim 6, wherein the second resolution has a lower vertical resolution than the first resolution.

8. The electronic device of claim 5, wherein in the first mode, the first memory reads each of the first line data from the rendering data to generate the first data.

9. The electronic device of claim 5, wherein in the second mode, the first memory reads the first line data corresponding to odd-numbered rows among the first line data from the rendering data to generate the first data.

10. The electronic device of claim 1, wherein the processor supplies mode data regarding a driving mode to the display device.

11. An electronic device comprising:
a display device including:
a data driver integrated circuit which converts interfacing data into second data; and
a display panel which displays an image based on the second data; and
a processor which processes raw image data and provides the interfacing data to the display device,
wherein the data driver IC: maintains a resolution of the second data at a first resolution, which is a resolution of the raw image data, in a first mode, and
changes the resolution of the second data to a second resolution different from the first resolution in a second mode different from the first mode.

12. The electronic device of claim 11, wherein the processor supplies mode data regarding a driving mode to the data driver integrated circuit.

13. The electronic device of claim 12, wherein the data driver integrated circuit includes:
a second memory which generates padding data based on the interfacing data; and
a scaler which generates the second data based on the padding data and the mode data.

14. The electronic device of claim 13, wherein in the second mode, the scaler scales the padding data to change a resolution of the padding data to the second resolution, and generates the second data based on the padding data.

15. The electronic device of claim 14, wherein the first resolution has a resolution of 1080 by 2160.

16. The electronic device of claim 15, wherein the second resolution has a resolution of 1440 by 1440.
